(19) United States
(12) Patent Application Publication
(10) Pub. No.: US 2023/0396650 A1
(43) Pub. Date: Dec. 7, 2023

(54) SYSTEM AND METHOD FOR PROVIDING SERVICES USING DIGITAL TWINS

(71) Applicant: FETCH.AI Limited, Bury St Edmunds (GB)

(72) Inventors: Devon Bleibtrey, Novi, MI (US); Humayun Sheikh, Bury St Edmunds (GB)

(21) Appl. No.: 17/829,612

(22) Filed: Jun. 1, 2022

(51) Int. Cl. H04L 9/40

(52) U.S. Cl. CPC H04L 63/20; H04L 63/10; H04L 63/0428

(57) ABSTRACT

Disclosed is a system for providing service(s) mutually interconnected with decentralised data communication network. Decentralised data communication network comprises users and entries of services offered by user(s). System comprises digital twin(s) of first user seeking service(s), wherein digital twin(s) is an autonomous economic agent; and digital representation(s) of second user providing service(s). Digital twin(s) of first user comprises processing module, processing module being configured to: process information pertaining to first user to determine parameters of service(s), search decentralised data communication network to shortlist entries from entries based on parameters of service(s), and perform first action(s) by selecting first entry from shortlisted entries for attaining service(s) for first user.

### TECHNICAL FIELD

This invention relates to digital twins. In particular, though not exclusively, this invention relates to a system for providing at least one service using a digital twin and a method for providing at least one service using a digital twin.

### BACKGROUND

As society geared towards technology in each and every aspect of daily life, digital markets have experienced a major boom. In this regard, multiple service facilitators from various fields have digitised access to the same. Each such facilitator partners with a few service providers to offer such services to consumers. Due to such widespread digitisation by such facilitators, there is a lot of information noise on the internet, making it increasingly difficult for people to find appropriate services. This does not allow the consumers to connect with appropriate service providers thereof.

Moreover, although plenty, such facilitators often do not meet consumer requirements as well, mostly due to limited partnerships with the service providers. Even if they do meet the consumer requirements, they often overcharge for the services provided, tacking on approximately 30% of costs being paid by the consumers. Such service facilitators not only empty pockets of the consumers, but also underpay the service providers who are doing actual work for providing services. Such service facilitators act as “middlemen” or “gatekeepers” in service industries, and govern centralised markets. Examples of such centralised markets are easily recognisable in fields of ride sharing, food delivery, consulting and retail.

Therefore, in light of the foregoing discussion, there exists a need to overcome the aforementioned drawbacks associated with centralised marketplaces controlled by middlemen.

### SUMMARY OF THE INVENTION

A first aspect, an embodiment of the present disclosure provides a system for providing at least one service mutually interconnected with a decentralised data communication network wherein the decentralised data communication network comprises a plurality of users and a plurality of entries of services offered by at least one user, the system comprising:
at least one digital twin of a first user seeking the at least one service, wherein the at least one digital twin is an autonomous economic agent; and
at least one digital representation of a second user providing the at least one service;
wherein the at least one digital twin of the first user comprises a processing module, the processing module being configured to:
   process information pertaining to the first user to determine parameters of the at least one service;
   search the decentralised data communication network to shortlist entries from the plurality of entries, based on the parameters of the at least one service; and
   perform at least one first action by selecting at least one first entry from the shortlisted entries, for attaining the at least one service for the first user.

It will be appreciated that the system for providing at the least one service facilitates data-based communication between the decentralised data communication network and itself. The system comprises specialized equipment configured to perform specialized tasks for effectively providing the at least one service.

Throughout the present disclosure, the term “decentralised data communication network” refers to a decentralised network which facilitates data communication between a plurality of digital nodes. The decentralised data communication network is not centralised, which means that it is not governed by a single entity, and therefore does not require any intermediaries for providing or seeking a service therewith. Moreover, the decentralised data communication network provides various tools, security protocols, rules and suchlike for the execution of tasks including, but not limited to, communication, processing of information and so forth, between different users associated with the decentralised data communication network. It will be appreciated that the decentralised data communication network may be representative of a real-world environment, such as a real-world market, wherein one or more services are provided and/or procured. The decentralised data communication network is beneficially adaptive in its hardware operation in response to a type of task being processed therethrough. A technical advantage of using the decentralised data communication network is that it eliminates (prior) reliability on intermediaries.

Optionally, the decentralised data communication network is based on blockchain technology. The blockchain technology refers to building a digital ledger of information, as a structure which stores records (as blocks), in a network connected via nodes (as chain). It will be appreciated that data of a blockchain is stored chronologically, such that each new record (i.e., block) is linked to a previous record and a next record (i.e., chain). Moreover, the blockchain is stored publicly, in multiple databases and devices, such that it may never be hacked, altered or deleted. Since the blocks of the blockchain are stored at multiple places, it is nearly impossible to hack into, alter or delete blockchain records. Optionally, the information is encrypted using cryptography. A technical advantage of using blockchain technology is to ensure that privacy of users is not compromised, and data cannot be altered. Optionally, the decentralised data communication network is a decentralised marketplace. Herein, the plurality of users may provide or seek services, based on the plurality of entries of services.

Optionally, the decentralised data communication network is built using a set of rules which dictate interactions within the decentralised data communication network. Herein, the set of rules block or allow communications between users. For example, the decentralised data communication network allows, when in operation, access to one or more users to operate within the decentralised data communication network based on the set of rules (and/or security protocols). Similarly, the decentralised data communication network may deny access to one or more users to operate within the decentralised data communication network upon determining that the users do not comply with the set of rules (and/or security protocols). Such set of rules are implemented as forms of cooperation between users providing services and users seeking services, such that honesty and transparency are maintained therewith. In an example, a rule may be requiring users to undergo a basic verification procedure (such as, an email-based verification, a phone-based verification, an identity-based verification, and so forth) to access the decentralised data communication network. In another example, a rule may be for users to authenticate a smart contract each time an entry of service is selected. A technical advantage of building the decentralised data communication network using the set of rules is that it is robust against third-party attacks, and ensures fairness to both kinds of users-providing services and seeking services.

Optionally, a plurality of decentralised data communication networks exist, wherein each decentralised data communication network is mutually interconnected with the system. Herein, each decentralised data communication network may provide a platform to provide services and/or seek services of a given type. For example, a first decentralised data communication network may allow the plurality of users to provide and/or seek services with respect to vehicles, i.e., a car parking service, a car cleaning service, a car re-filling service, and so forth; and a second decentralised data communication network may allow the plurality of users to provide and/or seek services with respect to beauty and wellness, i.e., a manicure service, a massage service, an eyelash service, and so forth.

The term “service” as used herein refers to an arrangement (namely, “means for”) performing an action (namely, an activity) and/or providing assistance for performing such an action. For example, the “service” optionally relates to providing a car parking, providing salon services, or washing hair. Embodiments of the present invention provide for automatic management of a service process which includes generation of a service request, broadcasting of the service request, generation of service bids in response to the service request, selecting one or more service providers (i.e., the second users) and providing the service to the first user, where in the selection of one or more users on the decentralised data communication network involve an autonomous decision made by the autonomous economic agent (or agents) managing such service processes.

The term “plurality of users” refers to users of the decentralised data communication network. Herein, the plurality of users include first users (i.e., users seeking the at least one service) and second users (i.e., users providing the at least one service). It will be appreciated that for each decentralised data communication network, there may be a plurality of first users which are seeking the at least one service and a plurality of second users which are providing the at least one service simultaneously. Moreover, a given second user may provide a plurality of services via the decentralised data communication network, and a given first user may seek a plurality of services via the decentralised data communication network.

The term “plurality of services” refer to the services being provided via the decentralised data communication network. As previously mentioned, such services may be of varied types and professions. Examples of some such services include, but are not limited to, listings for parking spaces, listings for jobs, listings for salon services, listings for travel bookings, and listings for household chores. It will be appreciated that the at least one service is selected from the plurality of services offered by the plurality of users on the decentralised data communication network.

Throughout the present disclosure, the term “digital twin” refers to a virtual representation of a given user. It will be appreciated that a given digital twin is updated in real-life, from real-time data. Moreover, the given digital twin employs simulation, machine learning and reasoning to assist in decision-making. Typically, the given digital twin spans a lifetime of the given user, however, a lifetime of the given digital twin may vary based on requirements of the given user. Moreover, the first user is a user seeking the at least one service, and the at least one digital twin of the first user is a virtual representation of the first user.

The given digital twin being an autonomous economic agent means that the given digital twin is capable of autonomously making decisions on behalf of the given user. The term “autonomous economic agent” (hereinafter referred to as “AEA”) refers to a software module that, autonomously, executes one or more technical tasks. It will be appreciated that the autonomous economic agent is capable of collecting, mining, harvesting and analysing information in order to make a decision and act upon the same. Moreover, the autonomous economic agent comprises at least one computing node (i.e., the processing module for the at least one digital twin of the first user). For example, the one or more technical tasks optionally include wired or wireless communication of AEAs with each other, processing of information and so forth. In an example, the AEA employs, when in operation, artificial intelligence (AI) algorithms (namely self-adjusting adaptive algorithms) and machine learning to execute the one or more tasks.

Optionally, the system is configured to build the digital twins using information pertaining to users, such information being at least one of: information mined from social media networks, information collected via a form, information mined from a user device. Optionally, the information pertaining to users is mined using at least one machine learning mining algorithm. Examples of such information include, but are not limited to, a present location, a plurality of recurrent locations, a like, a dislike, a requirement and a preference. For example, recent and recurrent locations of the given user may be mined to build the given digital twin, such that the given digital twin may appropriately find parking for the given user whenever the given user goes to work or their favourite restaurant. A technical benefit of building the digital twins using such information is that exhaustive and detailed information allows the digital twins to identify and predict requirements of the users. Another technical benefit of this is that such digital twins built with such information can identify patterns followed by the users, and thereby make customised decisions for the users. For example, if two users are seeking to buy a dress, the digital twins of such users may be able to identify which types of colours and styles each of the user prefers and order accordingly. In such an example, one user may prefer a fitted black dress, whereas the other user may prefer a bohemian blue dress. Herein, the digital twins of the two users would respectively place orders (i.e., perform the first action, as mentioned below) based on individual choices of the two users.

Herein, information mined from social media networks includes information mined from the given user's social media accounts, along with information from the given user's contacts on such social media networks and activities of the given user on the social media networks. The information collected via the form may be inputted by the given user onto the form itself, often manually. The information mined from the user device includes information mined from saved accounts on the user device, pictures, videos, messages and geolocation positioning system. It will be appreciated that the information mined from social media networks and the information mined from the user device are mined (i.e., extracted) automatically (i.e., without manual requirement), once the given user authorises the same.

The term “user device” refers to an interactive device, via which the given user is capable of accessing and interacting on the decentralised data communication network. Examples of the user device includes, but is not limited to, a computer, a smartphone, a laptop, a tablet, a smartwatch, and a phablet. For example, the user may use the decentralised data communication network to seek a hair spa service using his/her/their smartphone. In this example, the at least one digital twin of the user may be built using the information mined from their smartphone.

Optionally, the at least one digital twin of the first user comprises a digital identity which is a digital representation of a unique identity of the first user, and wherein the system is configured to allow data communication between the at least one digital twin of the first user and the at least one digital representation of the second user upon verification of the digital identity of the at least one digital twin of the first user, by the at least one digital representation of the second user.

Since the given digital twin is the virtual representation of the given user, the given digital twin comprises the digital identity. Herein, the digital identity corresponds with a real-world identity of the given user. Typically, real-world identities are provided with the unique identity (i.e., ID), which may be a series of numbers, alphabets and/or special characters denoted by an authority to the given user in a real-world environment. Examples of the unique ID include, but are not limited to, a social security number, a passport number, a driving license number and a healthcare record number. Moreover, the digital identity is expressed in form of a series of alphabets, numbers and special characters. Examples of the digital identity include, but are not limited to, a user ID generated by the decentralised data communication network, a name of the user, a username of the user, and a replica of the unique ID of the user. A technical advantage of the at least one digital twin having the digital identity is that it ensures authenticity of the given user on the decentralised data communication network, reducing chances of cyber-crime.

Optionally, the digital identity of the given user allows the digital twin of the given user to interact with digital twins of family of the given user. Herein, the term “family” refers to persons that the given user knows in real-life, including their family, their friends, their acquaintances, and so forth. For example, the given digital twin of the given user may connect with a digital twin of his sister, such that both such digital twins may share data and find appropriate services to provide. In this example, the digital twins may find that the given user and his sister enjoy karaoke, and book a karaoke place for their next get-together.

Moreover, when the at least one digital twin of the first user performs the first action by selecting the at least one first entry from the shortlisted entries, the system allows data communication between the at least one digital twin of the first user and the at least one digital representation of the second user via the decentralised data communication network. Herein, once the data communication is allowed, the digital identity (or, digital identities) of the user(s) must be verified before a data communication channel is installed therein. The digital identity may be verified by comparing the unique ID submitted by the given user to records of the authority. Herein, the digital identity of the at least one digital twin of the first user is verified by the at least one digital representation of the second user. Optionally, the digital identity of the given digital twin of the given user is verified by an automated process of the decentralised data communication network.

Optionally, the at least one digital twin of the first user receives at least one user authorisation from the first user via the user device, and wherein the at least one user authorisation is of at least one form of: a verbal authorisation, a written authorisation, a haptic authorisation, a pre-determined custom authorisation. Herein, the term “user authorisation” refers to a permission from the given user to allow the given digital twins to make decisions on their behalf. Such user authorisation may be a prior authorisation provided to the given digital twin. It will be appreciated that such user authorisation may be renewed at periodic intervals. Such periodic intervals may be weekly, monthly, yearly, and so forth. Moreover, such user authorisation may be direct or indirect. In an example, the given user may authorise the digital twin to find him a parking space by selecting such a written option on the decentralised data communication network. In another example, the given user may authorise the digital twin to find him a parking space every morning he touches a portion of his mirror.

It will be appreciated that the direct authorisation involves the given user to specifically provide authorisation for a specific task or group of tasks (which may have to be performed one or more times), whereas the indirect authorisation involves the user providing authorisation for services with or without specifying a type, time, date or more of the service. Notably, any form of the at least one user authorisation may be provided as either the direct authorisation or the indirect authorisation. Optionally, the at least one user authorisation is revocable by the given user.

The verbal authorisation requires the given user to verbally permit the given digital twin to perform at least one action. Herein, the given user may verbally state such a request or select such authorisation from a plurality of possible verbal requests. The written authorisation requires the given user to permit the given digital twin by providing a hand-written authorisation (in a natural language), providing a textual authorisation, selecting a textual authorisation from a plurality of possible written authorisations. The haptic authorisation may be provided by way of vibrations, wherein either the given user moves the user device to activate the haptic authorisation, or select from a plurality of haptic responses. The pre-determined custom authorisation refers to a conditional authorisation, and requires the given user to initially set the pre-determined custom authorisation and inform the same to the decentralised data communication network. For example, a pre-determined custom authorisation may be to provide a cup of coffee at a place of work of the given user, when the given user removes a tie from drawers. Herein, opening the drawers and taking out a tie is the pre-determined custom authorisation which thereby grants permission to the given digital twin to order coffee and get it delivered in a timely manner. A technical advantage of receiving the user authorisation from the given user is that it ensures security protocol and establishes the kind of services the given user wishes to seek.

The term “digital representation” refers to a digital profile of a given user. Optionally, a given digital representation is a digital computing node, capable of performing certain tasks in an automated manner. For example, the given digital representation may check for an availability in the given user's calendar before booking a hair spa appointment. Alternatively, optionally, the given digital representation is controlled by the given user. For example, the given user utilises the digital representation to communicate with the plurality of users on the decentralised data communication network. It will be appreciated that the digital representation is capable of performing basic computing tasks based on user authorisation, for providing the at least one service.

Optionally, the at least one digital representation of the second user is implemented as at least one digital twin, wherein the at least one digital twin of the second user comprises a digital identity which is a digital representation of a unique identity of the second user, and wherein the system is configured to allow data communication between the at least one digital twin of the first user and the at least one digital twin of the second user upon mutual verification of the digital identities of the at least one digital twin of the first user and the at least one digital twin of the second user. Herein, when the at least one digital twin of the first user performs the first action by selecting the at least one first entry from the shortlisted entries, the system allows data communication between the at least one digital twin of the first user and the at least one digital twin of the second user via the decentralised data communication network. Herein, once the data communication is allowed, the digital identities of the first user and the second user must be verified before a data communication channel is installed therein. The digital identities of the at least one digital twin of the first user and the at least one digital representation of the second user are mutually verified by each other. A technical advantage of the digital representation of the second user being is digital twin is that it automates actions of the second user, making it easier for the second user to provide services on the decentralised data communication network. Another technical advantage of this is that it allows the second user to connect with their family as well, and thereby offer customised services. For example, a hairdresser of colour may know how to style hair of coloured people better than an average hairdresser, due to experience. Thereby, considering this specialisation, such a hairdresser would be able to provide such customised services for curly hair to other persons of colour who require such customised care for their hair. In another example, a halal butcher would be able to connect with more people from their community who require halal meat, and provide the same to them.

Throughout the present disclosure, the term “processing module” refers to a processing device that performs data processing operations for providing the at least one service to at least one first user, which is seeking the at least one service via the decentralised data communication network. A given processing module could be external to its corresponding digital twin or could be integrated with its corresponding digital twin. Moreover, the processing module refers to hardware, software, firmware or a combination of these. It will be appreciated that the processing module of a given digital twin performs actions to seek or provide the at least one service thereof.

The processing module of the at least one digital twin of the first user is configured to process the information pertaining to the first user to determine the parameters of the at least one service. Herein, the information pertaining to the first user is mined from various sources as mentioned above. When processed, such information can provide many conclusions since the processing module is capable of identifying patterns and recognising requirements and choices. In a first example, if the first user is fond of cars and maintaining them, and the information pertaining to the first user reveals that the first user was recently in a minor car accident, and if the first user has plans of a road trip after two weeks, the processing module may determine the parameters of the at least one service to get the car fixed while managing required paperwork for insurance.

Optionally, the processing module employs at least one data processing algorithm to process the information pertaining to the first user. Examples of the data processing algorithm includes, but is not limited to, a random walk algorithm, a distributed hash table algorithm, a streaming algorithm, a bulk synchronous processing (BSP) algorithm, and a MapReduce algorithm. Moreover, parameters of the at least one service may be defined as labels which identify the at least one services. Examples of some parameters include, a type of service, a location of service, a date and time of service, and so forth.

Furthermore, the processing module of the at least one digital twin of the first user is configured to search the decentralised data communication network to shortlist entries from the plurality of entries based on the parameters of the at least one service. Optionally, the decentralised data communication network is searched using a searching algorithm. Examples of the searching algorithm include, but are not limited to, a linear search algorithm, a binary search algorithm, a jump search algorithm, an interpolation search algorithm, an exponential search algorithm, a sublist search algorithm, a Fibonacci search algorithm, and a ubiquitous binary search algorithm. It will be appreciated that the search is performed for the plurality of entries on the decentralised data communication network. In this regard, the processing module compares each entry from the plurality of entries with respect to the parameters of the at least one service. Entries which qualify each of the parameters of the at least one service during the search are thereafter shortlisted. With respect to the first example, the search may provide a list of mechanics who would fix the car within a fortnight, and accept money from the insurance of the first user.

Thereafter, the processing module of the at least one digital twin of the first user is configured to perform the at least one first action by selecting at least one first entry from the shortlisted entries, for attaining the at least one service for the first user. Herein, the processing module compares the shortlisted entries with respect to their respective advantages and disadvantages and selects the at least one first entry. The parameters of the at least one service dictate the selection or deselection of a given entry. Such deciding factors may be a cost involved, accessibility, a distance from the first user, and so forth. With respect to the first example, an entry having a lowest cost involved, fast delivery, and quality of work would be preferable over all others. Optionally, examples of a given action include sending a signal to the decentralised data communication network regarding a given entry, sending a message to the second user to inquire about the given entry, allowing location-sharing with the second user, and the like. More optionally, examples of the given action include booking a parking space, booking travel, getting a hair appointment, and the like. Notably, herein, “performing the at least one first action” is synonymous with “selection the at least one first entry”.

It will be appreciated that the system of the present disclosure beneficially provides the decentralised data communication network, wherein the plurality of users provide and/or seek the at least one service. Herein, since the network is decentralised, it eliminates a need of middlemen, allowing service providers (i.e., the second user) and service seekers (i.e., the first user) to connect directly. Additionally, the at least one digital twin of the first user facilitates selection and finalisation of service providers autonomously, which saves time and allows the plurality of users to focus on their passions and lives instead of constantly searching for services or customers.

Moreover, the processing module is optionally configured to perform a plurality of first actions with respect to the at least one first entry. With respect to the above example, a first action is selecting a mechanic for repairing the car. Another first action may be entering into a smart contract with the mechanic. Yet another first action may be putting a token amount as per a quote given by the mechanic into escrow, which would be transferred to the mechanic once the car is repaired and delivered back to the first user.

Optionally, when performing the at least one first action, the processing module is configured to perform intermediate steps related to availing the at least one service for the first user. Herein, such intermediate steps include, but are not limited to, running a credit check for the given user, performing security verification of payment information, verifying a digital signature in the smart contract, and providing a review of the at least one service availed. Notably, if the at least one service is not performed appropriately, alternate possibilities may ensue depending on the smart contract, which may provide compensation (i.e., in cash, kind, and the like) to the first user. For example, if the given user had a hotel booking which was denied during check-in due to overbooking, the given user may be liable for compensation of a similar room in another hotel.

Optionally, the at least one digital twin of the first user performs at least one second action by selecting at least one second entry for attaining at least one another service. It will be appreciated that the at least one digital twin also identifies and provides additional services related to the at least one service, that the first user may require. Herein, the processing module is configured to of the at least one digital twin of the first user is configured to perform the at least one second action by selecting at least one second entry for attaining at least one another service. With respect to the first example, a second action may be having gas in the car re-filled while the car is getting repaired at the mechanic. Another second action may be having dry-cleaned clothes for the trip delivered to the car while the car is parked with the mechanic. Optionally, the at least one digital twin of the first user performs a plurality of actions by selecting a plurality of entries for attaining a plurality of services for the first user. A technical advantage of the at least one digital twin performing the at least one second action is that it dynamically identifies similar requirements and ensures that tasks are performed autonomously, allowing the first user to focus on their passions and family without having stress regarding other miscellaneous activities they ought to do. Another technical advantage of this is that it ensures that all related services are availed at once, providing robustness and accessibility.

Optionally, the decentralised data communication network is configured to employ adaptive data encryption and data obfuscation processing operations depending upon one or more parameters of a given service, to provide a degree of data protection. Herein, such adaptive data encryption and data obfuscation processing operations garner a degree of data protection to the system, making it safer against hacking attacks. Optionally, the data is being encrypted using any suitable method of data encryption. Optionally, data is randomised before encryption for increased security. By enhancing the degree of data protection, the decentralised data communication network is less prone to being disrupted by malicious third parties, for example by injection of computer viruses or by selective eavesdropping and substitution of data flows within the decentralised data communication network. By employing data protection within the decentralised data communication network that is adaptively adjusted depending upon the parameters of the at least one service implemented within the system, the system can be both highly efficient in its operation and also highly robust to attack. Furthermore, the adaptive data encryption and data obfuscation advantageously make the decentralised data communication network robust, and prevent it from unwanted intrusions, for example third-part malicious attacks. Moreover, adaptive data encryption employed by the given digital twin encrypts the data being exchanged based on the type of data. Moreover, such data includes the confidence factor of the given digital twin, information associated with remuneration, service request, service bids, and so forth.

Optionally, when the decentralised data communication network is in operation, the adaptive data encryption and data obfuscation processing operations are selected depending upon at least one of: a temporal rate of execution of services via a given node of the decentralised data communication network, considerations associated with services being executed via a given node of the decentralised data communication network. It will be appreciated that combinations of obfuscation, for example swapping of nibbles of bytes, and encryption (likewise, corresponding de-obfuscation and decryption) are capable of approaching a “one time pad” degree of data protection which can only be attacked by using extreme amounts of data processing resources that would not normally be available to malicious third parties.

Optionally, the adaptive data encryption and data obfuscation processing operations comprise a combination of following data protection processes: encryption, decryption, data obfuscation by swapping one or more bits of data bytes, addition of obfuscating redundant data temporally randomised transmission times for data within the decentralised data communication network. It will be appreciated that the obfuscating redundant data refers to data decoys, which are included to increase security and ensure safety of data. Optionally, the given digital twin encrypts a given action by employing intelligent algorithms to secure the decentralised data communication network, wherein the intelligent algorithms include adaptive data encryption and data obfuscation techniques, for example as aforementioned using various combinations of data encryption/decryption, data obfuscation, data padding with decoy redundant data and temporal obfuscation by creating stochastic uncertainty of malicious third-parties when a given communication is communicated within the decentralised data communication network; such operation of the intelligent algorithms affect a manner in which the decentralised data communication network functions technically. A technical advantage of utilising the above-mentioned data protection processes is that it allows security against hackers and threats, and ensures data privacy and security.

A method for providing at least one service, the method comprising:
building a decentralised data communication network, wherein the decentralised data communication network comprises a plurality of users and a plurality of entries of services offered by at least one user;
building at least one digital twin of a first user seeking the at least one service, wherein the at least one digital twin is an autonomous economic agent, and wherein the at least one digital twin is mutually interconnected with the decentralised data communication network;
building at least one digital representation of a second user providing the at least one service, wherein the at least one digital representation is mutually interconnected with the decentralised data communication network;
processing information pertaining to at least the first user to determine parameters of the at least one service;
searching the decentralised data communication network to shortlist entries from the plurality of entries, based on the parameters of the at least one service; and
performing at least one first action by the at least one digital twin of the first user selecting at least one first entry from the shortlisted entries, for attaining the at least one service for the first user.

Optionally, the at least one digital twin of the first user comprises a digital identity which is a digital representation of a real-world identity of the first user, and wherein the method further comprises allowing data communication between the at least one digital twin of the first user and the at least one digital representation of the second user upon verification of the digital identity of the at least one digital twin of the first user, by the at least one digital representation of the second user.

Optionally, the method comprises receiving at least one user authorisation from the first user via the user device, by the at least one digital twin of the first user, prior to the step of processing information, and wherein the at least one user authorisation is of at least one form of: a verbal authorisation, a written authorisation, a haptic authorisation, a pre-determined custom authorisation.

Optionally, the step of building the decentralised data communication network comprises using a set of rules which dictate interactions within the decentralised data communication network.

Optionally, the method further comprises performing at least one second action, by the at least one digital twin of the first user selecting at least one second entry for attaining at least one another service.

Optionally, the at least one digital representation of the second user is implemented as at least one digital twin, wherein the at least one digital twin of the second user comprises a digital identity which is a digital representation of a unique identity of the second user, and wherein the method further comprises allowing data communication between the at least one digital twin of the first user and the at least one digital twin of the second user upon mutual verification of the digital identities of the at least one digital twin of the first user and the at least one digital twin of the second user.

Optionally, the method further comprises employing, by the decentralised data communication network, adaptive data encryption and data obfuscation processing operations depending upon one or more parameters of a given service, to provide a degree of data protection.

Optionally, when the decentralised data communication network is in operation, the adaptive data encryption and data obfuscation processing operations are selected depending upon at least one of: a temporal rate of execution of services via a given node of the decentralised data communication network, considerations associated with services being executed via a given node of the decentralised data communication network.

Optionally, the adaptive data encryption and data obfuscation processing operations employ a combination of following data protection processes: encryption, decryption, data obfuscation by swapping one or more bits of data bytes, addition of obfuscating redundant data, temporally randomised transmission times for data within the decentralised data communication network.

Throughout the description and claims of this specification, the words “comprise” and “contain” and variations of the words, for example “comprising” and “comprises”, mean “including but not limited to”, and do not exclude other components, integers or steps. Moreover, the singular encompasses the plural unless the context otherwise requires: in particular, where the indefinite article is used, the specification is to be understood as contemplating plurality as well as singularity, unless the context requires otherwise.

Preferred features of each aspect of the invention may be as described in connection with any of the other aspects. Within the scope of this application, it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible.

### BRIEF DESCRIPTION OF THE DRAWINGS

One or more embodiments of the invention will now be described, by way of example only, with reference to the following diagrams wherein:

FIG. 1 is a block diagram representing a system for providing at least one service, in accordance with an embodiment of the present disclosure;

FIG. 2 is a process flow depicting steps of a method for providing at least one service, in accordance with an embodiment of the present disclosure; and

FIG. 3 is an exemplary process flow depicting actions being performed by a processing module of at least one digital twin of a first user, in accordance with an embodiment of the present disclosure.

### DETAILED DESCRIPTION OF THE DRAWINGS

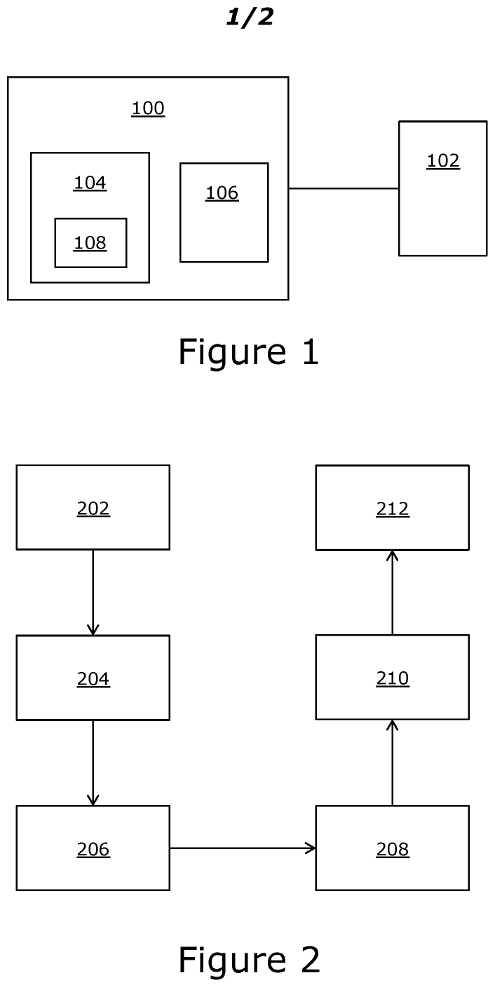

Referring to FIG. 1, illustrated is a block diagram representing a system 100 for providing at least one service, in accordance with an embodiment of the present disclosure. The system 100 is mutually interconnected with a decentralised data communication network 102. The system 100 comprises at least one digital twin (depicted as a digital twin 104) of a first user seeking the at least one service, and at least one digital representation (depicted as a digital representation 106) of a second user providing the at least one service. Furthermore, the digital twin 104 of the first user comprises a processing module 108.

Referring to FIG. 2, illustrated is a process flow depicting steps of a method for providing at least one service, in accordance with an embodiment of the present disclosure. At 202, a decentralised data communication network is built, wherein the decentralised data communication network comprises a plurality of users and a plurality of entries of services offered by at least one user. At 204, at least one digital twin of a first user seeking the at least one service is built, wherein the at least one digital twin is an autonomous economic agent, and wherein the at least one digital twin is mutually interconnected with the decentralised data communication network. At 206, at least one digital representation of a second user providing the at least one service is built, wherein the at least one digital representation is mutually interconnected with the decentralised data communication network. At 208, information pertaining to at least the first user is processed to determine parameters of the at least one service. At 210, the decentralised data communication network is searched to shortlist entries from the plurality of entries, based on the parameters of the at least one service. At 212, at least one first action is performed by the at least one digital twin of the first user selecting at least one first entry from the shortlisted entries, for attaining the at least one service for the first user.

The aforementioned steps are only illustrative and other alternatives can also be provided where one or more steps are added, one or more steps are removed, or one or more steps are provided in a different sequence without departing from the scope of the claims herein.

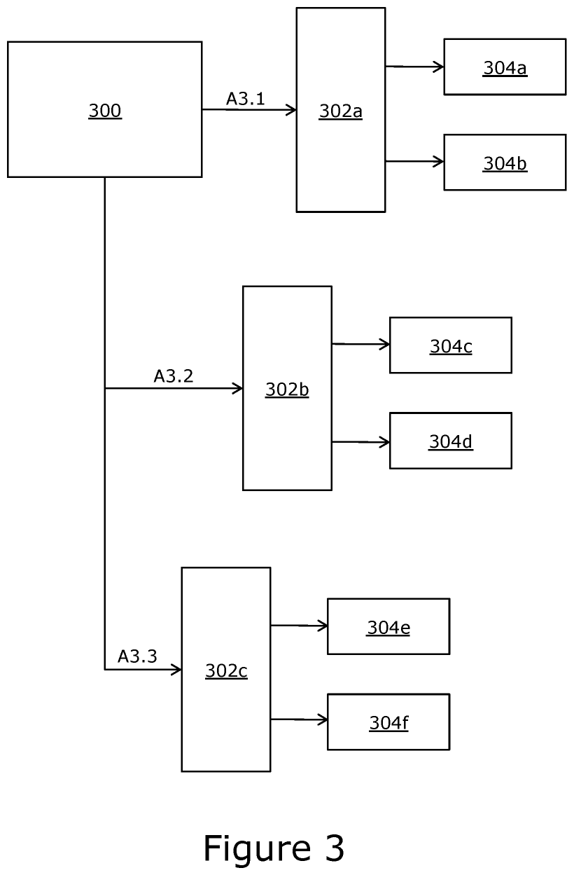

Referring to FIG. 3, illustrated is an exemplary process flow depicting actions being performed by a processing module 300 of at least one digital twin of a first user, in accordance with an embodiment of the present disclosure. Firstly, the processing module 300 performs a first action A3.1 at a first decentralised data communication network 302a, wherein services are provided by a first digital representation 304a and a second digital representation 304b. Secondly, the processing module 300 performs a second action A3.2 at a second decentralised data communication network 302b, wherein services are provided by a third digital representation 304c and a fourth digital representation 304d. Lastly, the processing module 300 performs a third action A3.3 at a third decentralised data communication network 302c, wherein services are provided by a fifth digital representation 304e and a sixth digital representation 304f. For example, the processing module 300 of the at least one digital twin of the first user is searching for motorcycle-related services. In this example, the processing module may perform the first action A3.1 as finding a mechanic for motorcycle servicing at a motorcycle servicing network 302a, the second action A3.2 as motorcycle cleaning at a motorcycle cleaning network 302b, and the third action A3.3 as a fuel delivery at a fuel delivery network 302c.

FIG. 3 is merely an example, which should not unduly limit the scope of the claims herein. A person skilled in the art will recognize many variations, alternatives, and modifications of embodiments of the present disclosure.

What is claimed is:

1. A system for providing at least one service mutually interconnected with a decentralised data communication network wherein the decentralised data communication network comprises a plurality of users and a plurality of entries of services offered by at least one user, the system comprising:
at least one digital twin of a first user seeking the at least one service, wherein the at least one digital twin is an autonomous economic agent; and
at least one digital representation of a second user providing the at least one service;
wherein the at least one digital twin of the first user comprises a processing module, the processing module being configured to:
process information pertaining to the first user to determine parameters of the at least one service;
search the decentralised data communication network to shortlist entries from the plurality of entries, based on the parameters of the at least one service; and
perform at least one first action by selecting at least one first entry from the shortlisted entries, for attaining the at least one service for the first user.

2. The system of claim 1, wherein the system is configured to build the digital twins using information pertaining to users, such information being at least one of: information mined from social media networks, information collected via a form, information mined from a user device.

3. The system of claim 1, wherein the at least one digital twin of the first user comprises a digital identity which is a digital representation of a unique identity of the first user, and wherein the system is configured to allow data communication between the at least one digital twin of the first user and the at least one digital representation of the second user upon verification of the digital identity of the at least one digital twin of the first user, by the at least one digital representation of the second user.

4. The system of claim 1 wherein the at least one digital twin of the first user receives at least one user authorisation from the first user via the user device, and wherein the at least one user authorisation is of at least one form of: a verbal authorisation, a written authorisation, a haptic authorisation, a pre-determined custom authorisation.

5. The system of claim 1, wherein the decentralised data communication network is built using a set of rules which dictate interactions within the decentralised data communication network.

6. The system of claim 1, wherein the at least one digital twin of the first user performs at least one second action by selecting at least one second entry for attaining at least one another service.

7. The system of claim 1, wherein the at least one digital representation of the second user is implemented as at least one digital twin, wherein the at least one digital twin of the second user comprises a digital identity which is a digital representation of a unique identity of the second user, and wherein the system is configured to allow data communication between the at least one digital twin of the first user and the at least one digital twin of the second user upon mutual verification of the digital identities of the at least one digital twin of the first user and the at least one digital twin of the second user.

8. The system of claim 1, wherein the decentralised data communication network is configured to employ adaptive data encryption and data obfuscation processing operations depending upon one or more parameters of a given service, to provide a degree of data protection.

9. The system of claim 8, wherein when the decentralised data communication network is in operation, the adaptive data encryption and data obfuscation processing operations are selected depending upon at least one of: a temporal rate of execution of services via a given node of the decentralised data communication network, services being executed via a given node of the decentralised data communication network.

10. The system of claim 9, wherein the adaptive data encryption and data obfuscation processing operations comprise a combination of following data protection processes: encryption, decryption, data obfuscation by swapping one or more bits of data bytes, addition of obfuscating redundant data temporally randomised transmission times for data within the decentralised data communication network.

11. A method for providing at least one service, the method comprising:
building a decentralised data communication network, wherein the decentralised data communication network comprises a plurality of users and a plurality of entries of services offered by at least one user;
building at least one digital twin of a first user seeking the at least one service, wherein the at least one digital twin is an autonomous economic agent, and wherein the at least one digital twin is mutually interconnected with the decentralised data communication network;
building at least one digital representation of a second user providing the at least one service, wherein the at least one digital representation is mutually interconnected with the decentralised data communication network;
processing information pertaining to at least the first user to determine parameters of the at least one service;
searching the decentralised data communication network to shortlist entries from the plurality of entries, based on the parameters of the at least one service; and
performing at least one first action by the at least one digital twin of the first user selecting at least one first entry from the shortlisted entries, for attaining the at least one service for the first user.

12. The method of claim 11, wherein the step of building the digital twins comprises using information pertaining to users, such information being at least one of: information mined from social media networks, information collected via a form, information mined from a user device.

13. The method of claim 11, wherein the at least one digital twin of the first user comprises a digital identity which is a digital representation of a real-world identity of the first user, and wherein the method further comprises allowing data communication between the at least one digital twin of the first user and the at least one digital representation of the second user upon verification of the digital identity of the at least one digital twin of the first user, by the at least one digital representation of the second user.

14. The method of claim 11, wherein the method comprises receiving at least one user authorisation from the first user via the user device, by the at least one digital twin of the first user, prior to the step of processing information, and wherein the at least one user authorisation is of at least one form of: a verbal authorisation, a written authorisation, a haptic authorisation, a pre-determined custom authorisation.

15. The method of claim 11, wherein the step of building the decentralised data communication network comprises using a set of rules which dictate interactions within the decentralised data communication network.

16. The method of claim 11, wherein the method further comprises performing at least one second action, by the at least one digital twin of the first user selecting at least one second entry for attaining at least one another service.

17. The method of claim 11, wherein the at least one digital representation of the second user is implemented as at least one digital twin, wherein the at least one digital twin of the second user comprises a digital identity which is a digital representation of a unique identity of the second user, and wherein the method further comprises allowing data communication between the at least one digital twin of the first user and the at least one digital twin of the second user upon mutual verification of the digital identities of the at least one digital twin of the first user and the at least one digital twin of the second user.

18. The method of claim 11, wherein the method further comprises employing, by the decentralised data communication network, adaptive data encryption and data obfuscation processing operations depending upon one or more parameters of a given service, to provide a degree of data protection.

19. The method of claim 18, wherein when the decentralised data communication network is in operation, the adaptive data encryption and data obfuscation processing operations are selected depending upon at least one of: a temporal rate of execution of services via a given node of the decentralised data communication network, services being executed via a given node of the decentralised data communication network.

20. The method of claim 19, wherein the adaptive data encryption and data obfuscation processing operations employ a combination of following data protection processes: encryption, decryption, data obfuscation by swapping one or more bits of data bytes, addition of obfuscating redundant data, temporally randomised transmission times for data within the decentralised data communication network.
